(19) United States
(12) Patent Application Publication
(10) Pub. No.: US 2006/0185883 A1
(43) Pub. Date: Aug. 24, 2006

(54) Method of marketing electrical conductor enclosures using application-specific customized packaging

(76) Inventor: Albert Santelli JR., Middlesex, NJ (US)

Correspondence Address: DUANE MORRIS LLP, PO BOX 5203, PRINCETON, NJ, 08543-5203, US

(21) Appl. No.: 11/337,305

(22) Filed: Jan. 23, 2006

Related U.S. Application Data
(60) Provisional application No. 60/646,083, filed on Jan. 21, 2005.

(51) Int. Cl. H01B 7/00

(52) U.S. Cl. 174/72 A

(57) ABSTRACT

A method of bundling a wire management kit including preselecting an assortment of wire enclosures and enclosure connectors suitable for a typical end user application; and packaging the preselected assortment of wire enclosures and enclosure connectors into a package that is suitable for retail sale. Each customized wire management kit would have an appropriate number and lengths of wire enclosures and an appropriate number and variety of enclosure connectors for the particular intended end user application to minimize the waste of materials while ensuring that sufficient wire enclosures and enclosure connectors are provided in each wire management kit.

### RELATED APPLICATIONS

This application claims the benefit of U.S. Provisional Application No. 60/646,083, filed on Jan. 21, 2005, the entire disclosure of which is incorporated herein by reference.

### FIELD OF THE INVENTION

This invention relates to a method of bundling a wire management kit by preparing and packaging an assortment of wire enclosures and enclosure connectors suitable for a typical end user application.

### BACKGROUND OF THE INVENTION

Electrical conductors, such as telephone lines, data cables, and power cables, to name a few (collectively and interchangeably referred to herein as “wire” or “wires”), which extend along exposed surfaces of exterior or interior panels, walls, ceilings, and floors of structures located in residential, commercial, and industrial environments, are typically contained in various types of enclosures. The enclosures manage, mechanically protect, and in some applications, shield the wires from electromagnetic radiation.

One desirable method for enclosing the wires is to use molded or extruded plastic enclosures such as raceways and ducts. These enclosures typically include multiple elongated wire enclosure sections that are joined by enclosure connectors of various configurations, such as inside elbow connectors, outside elbow connectors, flat elbow (90-degree-turn) connectors, straight coupling connectors and T-shaped connectors. The connectors enable the elongated wire enclosure sections to be connected and/or routed in various directions, e.g. around corners, etc., thus, adapting the enclosures to a particular installation. Such wire enclosures provide good mechanical protection for the wires, are relatively inexpensive, and low in weight.

In applications where electromagnetic shielding of the wires is desired, shielded enclosures made from molded or extruded plastic having electromagnetic shielding properties may be used. Such plastic composition may include one or more components which absorb and/or reflect electromagnetic radiation. Such wire enclosures provide good mechanical protection for the wires, are relatively inexpensive, and low in weight. In another type of wire enclosure, metallic foil shielding material may be incorporated into the plastic wire enclosure structure.

The electrical conductor enclosures are generally available in hardware stores in bulk lengths, for example, in long segments of 5 feet, 6 feet or 8 feet in length. The end users are expected to buy these long segments of the electrical conductor enclosures and cut them into desired lengths depending on the end user's particular application. If an end user needs to organize audio and power cables running among various audio equipment in his/her home entertainment cabinet, the end user has to measure the lengths of the various segments of the audio and power cables that require enclosure to calculate how much of the electrical conductor enclosures he/she should purchase. In addition, the end user must determine how many and what type of the connector pieces are required to connect the electrical conductor enclosures to one another. For many of the members of the general population, this process is too cumbersome and/or intimidating and they either opt to use a hired help to complete the work, which can be expensive, or abandon the work all together.

Hence, there is a need in the market place to provide the end user consumers with wire management kits that would make the job of organizing wires, cables, and cords connecting their audio equipment, video equipment, computer equipment and the like easier and less intimidating.

### SUMMARY

The terms wire(s), cord(s) and cable(s) are collectively and interchangeably referred to herein as wire(s). According to an aspect of the invention, a method of bundling a wire management kit comprises determining for a selected end user application the type or types of wire enclosures suitable for the selected end user application, the number of the wire enclosures suitable for the selected end user application and the dimensions of the wire enclosures suitable for the selected end user application; determining for the selected end user application the type or types of wire enclosure connectors suitable for the selected end user application, the number of the wire enclosure connectors suitable for the selected end user application and the dimensions of the wire enclosure connectors suitable for the selected end user application; producing, generating or otherwise obtaining the determined wire enclosures and wire enclosure connectors; and bundling the wire enclosures and the wire enclosure connectors into a package as a customized wire management kit suitable for retail sale. In other words, each kit contains a customized assortment of wire enclosures and connectors for the kit's intended end user application. A variety of different wire management kits may be defined for each of a variety of end user applications. Some examples of typical end user applications are: home computer systems; home entertainment systems; home video systems; home audio systems; and a home air filtration systems.

Each customized wire management kit has an appropriate type(s), number and size(s) of wire enclosures and an appropriate type(s), number and size(s) of wire enclosure connectors for the particular intended end user application to minimize the waste of materials while ensuring that sufficient wire enclosures and wire enclosure connectors are provided in each wire management kit. Thus, the method of the invention eliminates the need for an end user to struggle with trying to determine how much of the bulk lengths wire enclosures, that are conventionally available, and how many of the various enclosure connectors are necessary for the end user's particular application.

### BRIEF DESCRIPTION OF THE DRAWINGS

FIG. 1 is a perspective view of a wire enclosure used in the wire management kit of the invention.

FIG. 2 is a cross-sectional view of the wire enclosure of FIG. 1 with its cover closed.

FIG. 3 is an illustration of an assortment of wire enclosures and wire enclosure connectors for a wire management kit formed by a method of the invention.

FIG. 4 is an illustration of another assortment of wire enclosures and wire enclosure connectors for a second wire management kit formed by a method of the invention.

FIG. 5 is an illustration of yet another assortment of wire enclosures and wire enclosure connectors for a third wire management kit formed by a method of the invention.

FIG. 6 is a flow chart illustrating the method of the invention.

### DETAILED DESCRIPTION OF THE INVENTION

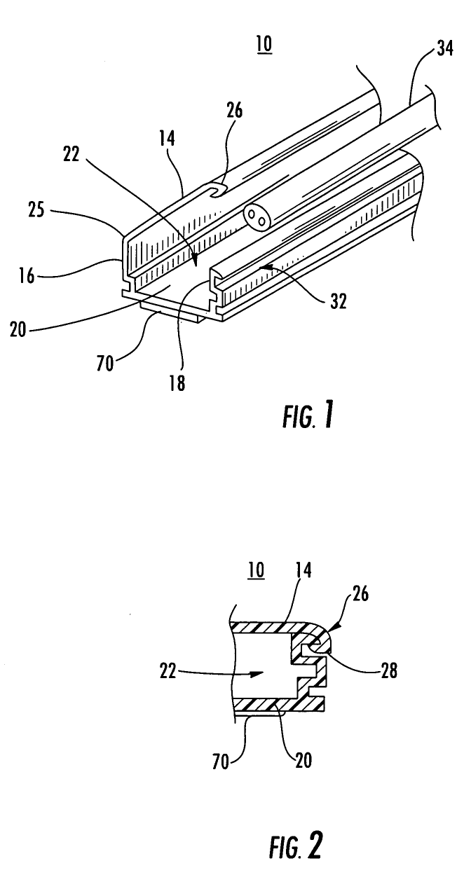

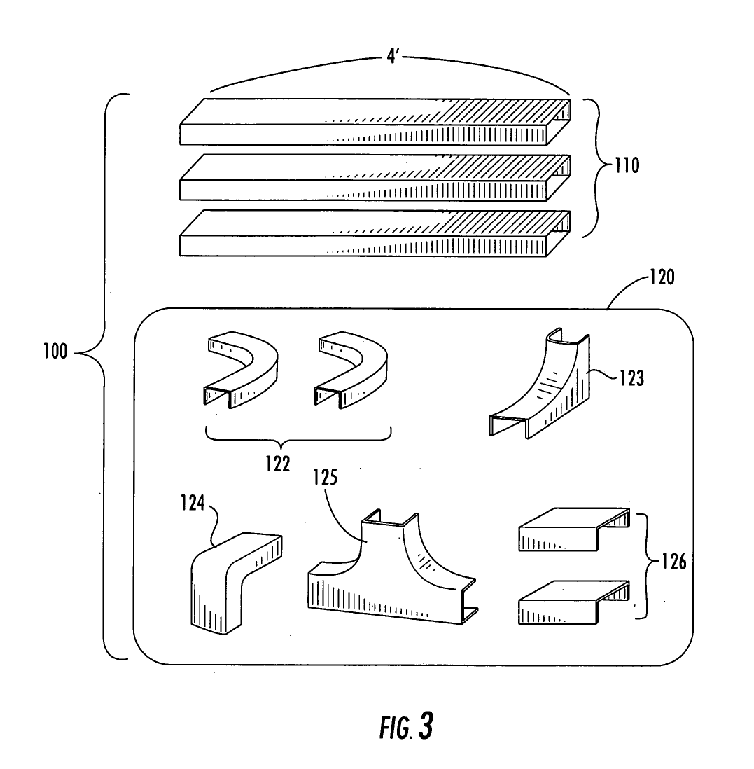

Illustrated in FIG. 1 is an example of a wire enclosure 10 that may be included in a wire management kit. The wire enclosure 10 shown herein is configured as a surface raceway comprising an elongated receptacle 12 and a cover 14 for the receptacle 12. The receptacle 12 includes a first side wall 16, a second side wall 18 opposite the first side wall 16 and extending generally parallel thereto, and a stepped bottom wall 20 connecting the first and second side walls 16, 18. The side walls 16, 18 and bottom wall 20 define an interior space 22 which receives one or more wires 34 including but not limited to telephone lines, data cables, and power cables. The outer surface of the bottom wall 20 is typically provided with a strip of adhesive tape 70 for mounting the wire enclosure 10 to a surface such as cabinets or walls. Other types of adhesive or mechanical means (e.g. nails, screws, etc.) of attaching the wire enclosure 10 may be utilized. The cover 14 permits easy access to the interior space 22 of the receptacle 12 at any time thus, permitting the wires 34 to be conveniently laid into or removed from the enclosure 10.

The cover 14 can be pivotally attached to the first side wall 16 of the receptacle 12 using a unitarily formed flexible living hinge 25. Alternatively, the cover 14 can be a separately applied element (not shown). As shown in the cross-sectional view of the wire enclosure 10 with the cover 14 in a closed state, a latch arrangement 26 is provided for securing the cover 14 to the receptacle 12. The latch arrangement 26 comprises an inward projection 28 formed on an edge 30 of the cover 14 opposite the hinge 25, and a corresponding groove 32 formed in the second side wall 18 of the receptacle 12.

The wire enclosures may be made using any suitable well known plastic forming method, with plastic extrusion being the preferred method. Extruded enclosures are preferably made by formulating the plastic composition directly in the extruder as the enclosure is being extruded therefrom.

The plastic material used for fabricating the wire enclosure 10 can include polyvinyl chloride, thermoplastic nylons, polyethylene, polypropylene, polystyrene, acrylate resins, polyester resins, thermoplastic rubber and other like plastics. Inert additives materials such as calcium carbonate or talc which aid in the enclosure forming process can be added if desired.

Where electromagnetic shielding of the wires 34 is desired, the wire enclosure 10 may be fabricated from a plastic composition having electromagnetic shielding properties. More specifically, the receptacle 12 and cover 14 may be fabricated from a plastic composition that includes one or more components that absorb and/or reflect electromagnetic waves. Thus, electromagnetic radiation external to the wire enclosure 10 is substantially prevented from entering the interior space 22 of the wire enclosure 10 and being transmitted by wires 34 to be contained therein. Further, electromagnetic radiation generated by the wires 34 inside the enclosure 10 is substantially prevented from being emitted therefrom and interfering with various electronic devices adjacent the enclosure 10.

To achieve the electromagnetic shielding properties of the wire enclosure 10, ferrite and/or other suitable metals may be added to the plastic composition of the wire enclosure 10. The electromagnetic shielding property can be varied by increasing or decreasing the quantity of the electromagnetic shielding component(s) in the plastic composition for the wire enclosure 10. It should be understood, however, that there are limitations on the quantity of ferrite powder and/or metal powder used in the plastic composition. If the quantity of ferrite powder and/or metal powder in the plastic composition is too low, the electromagnetic shielding properties of the enclosure 10 will be insufficient. Conversely, if the quantity of ferrite powder and/or metal powder in the plastic mixture is too high, the molding process and mechanical strength of the enclosure 10 will be substantially diminished.

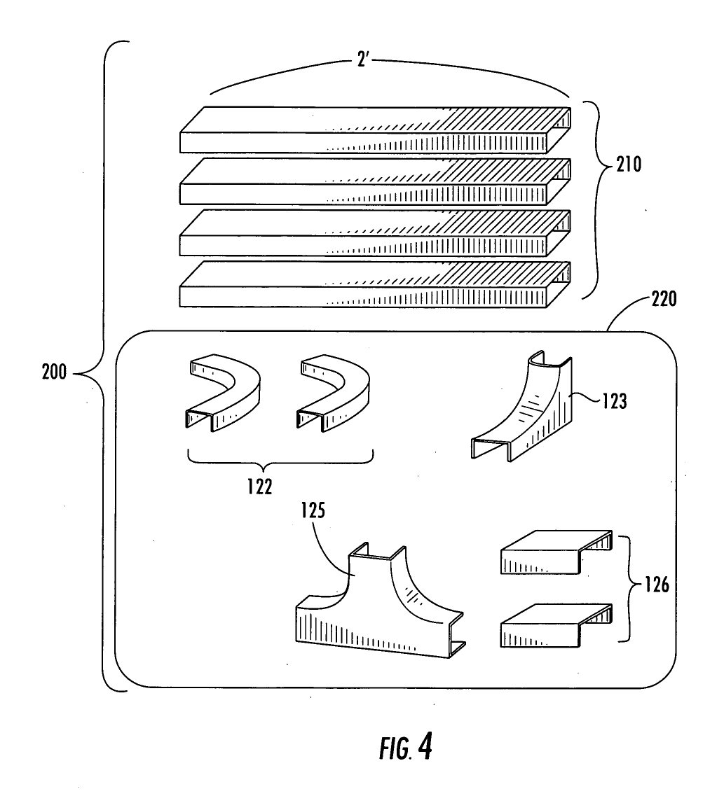

Illustrated in FIG. 3 is a wire management kit 100 for a computer system according to an embodiment. The wire management kit 100 comprises an assortment of wire enclosures 110 and wire connectors 120. The wire management kit 100 contains three (3) wire enclosures 110 (of the same type or any combination of types as predetermined to be necessary for a typical computer system, e.g., with or without electromagnetic shielding; hinged or non-hinged covers; and/or adhesive or mechanical fastening means, and other suitable and appropriate hardware items.), each ¾ inches wide and four (4) foot long; two (2) flat elbows 122; one (1) inside elbow 123; one (1) outside elbow 124; one (1) T-fitting 125; and two (2) couplings 126.

Although not shown, a wire management kit for a computer system according to another embodiment, may contain six (6) of the earlier mentioned wire enclosures, each ¾ inches wide and one (1) foot long; two (2) elbows; two (2) T-fittings; and five (5) couplings and three (3) end or terminating caps. A wire management kit for computer peripheral equipment according to an embodiment, may contain four (4) of the earlier mentioned wire enclosures, each ½ inches wide and one (1) foot long; two (2) elbows; one (1) T-fitting; and three (3) couplings and three (3) end or terminating caps.

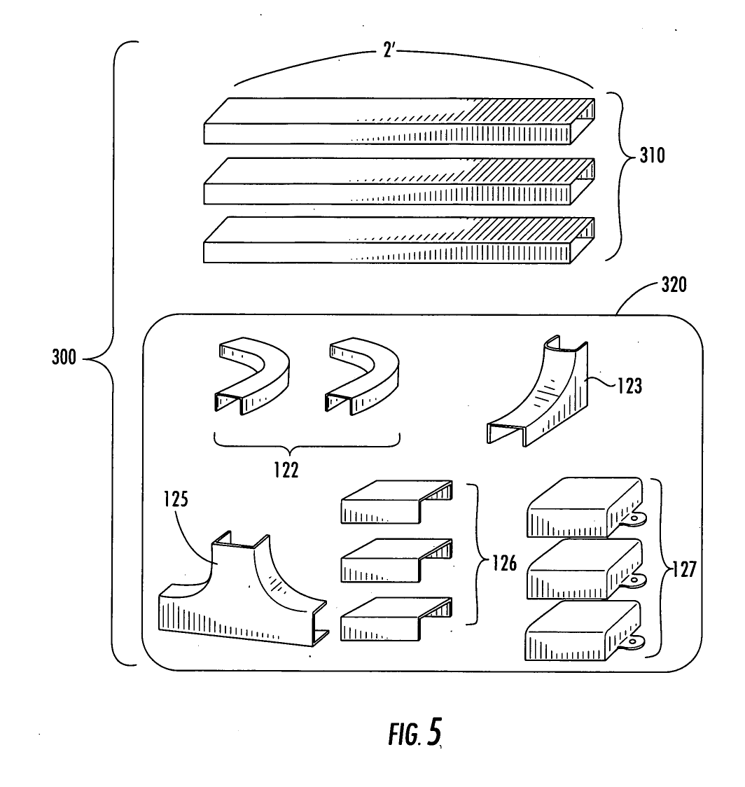

Illustrated in FIG. 4 is a wire management kit 200 for an audio system according to another embodiment. The wire management kit 200 comprises an assortment of wire enclosures 210 and wire connectors 220. The wire management kit 200 contains four (4) wire enclosures 210 (of the same type or any combination of types as predetermined to be necessary for a typical audio system, e.g., with or without electromagnetic shielding; hinged or non-hinged covers; and/or adhesive or mechanical fastening means, and other suitable and appropriate hardware items.), each ¾ inches wide and two (2) feet long; two (2) flat elbows 122; one (1) inside elbow 123; one (1) T-fitting 125; and two (2) couplings 126.

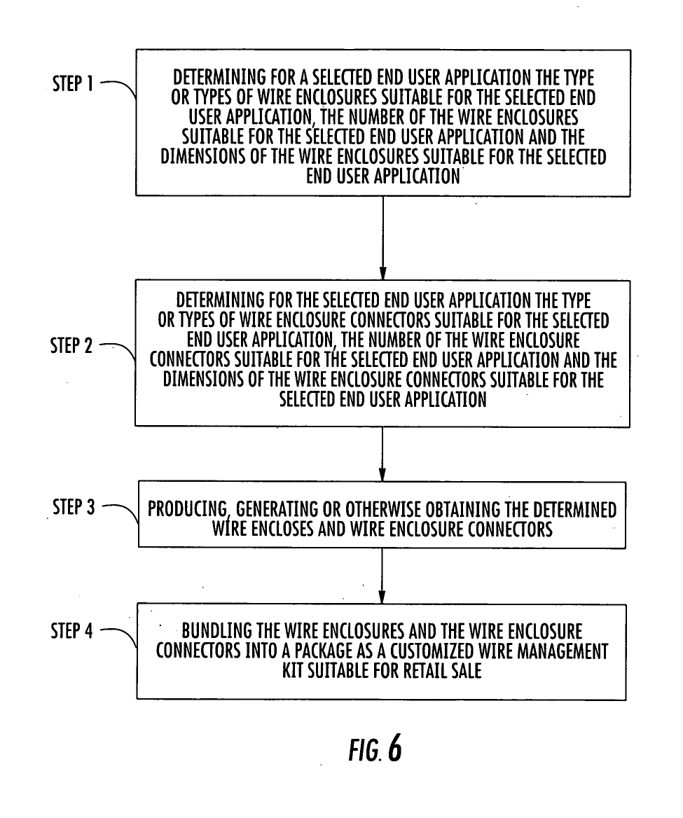

Illustrated in FIG. 5 is a wire management kit 300 for a DVD, VCR, Receiver home entertainment system according to another embodiment. The wire management kit 300 comprises an assortment of wire enclosures 310 and wire connectors 320. The wire management kit 300 contains three (3) wire enclosures 310 (of the same type or any combination of types as predetermined to be necessary for a typical home entertainment system, e.g., with or without electromagnetic shielding; hinged or non-hinged covers; and/or adhesive or mechanical fastening means, and other suitable and appropriate hardware items.), each ¾ inches wide and two (2) feet long; two (2) flat elbows 122; one (1) inside elbow 123; one (1) T-fitting 125; three (3) couplings 126; and three (3) end or terminating caps 127.

FIG. 6 is a flow chart illustration of the method of bundling a wire management kit according to an embodiment. Step 1 comprises determining for a selected end user application the type or types of wire enclosures suitable for the selected end user application, the number of the wire enclosures suitable for the selected end user application and the dimensions of the wire enclosures suitable for the selected end user application. Step 2 comprises determining for the selected end user application the type or types of wire enclosure connectors suitable for the selected end user application, the number of the wire enclosure connectors suitable for the selected end user application and the dimensions of the wire enclosure connectors suitable for the selected end user application. Step 3 comprises producing, generating, or otherwise obtaining the determined wire enclosures and wire enclosure connectors. Step 4 comprises bundling the wire enclosures and the wire enclosure connectors into a package as a customized wire management kit suitable for retail sale wherein the kit contains a customized assortment of wire enclosures and connectors for the kit's intended end user application.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

We claim:

1. A method of making a wire management kit, the method comprising the steps of:
determining a type or types of wire enclosures that are suitable for a selected end user application and a number of the type or types of wire enclosures suitable for the selected end user application;
obtaining the determined wire enclosures; and
packaging the obtained wire enclosures into a package, the package forming the wire management kit.

2. The method of claim 1, wherein the determining step includes determining dimensions of the type or types of wire enclosures suitable for the selected end user application.

3. The method of claim 1, wherein the wire management kit is for retail sale.

4. The method claim 1, further comprising the steps of:
determining a type or types of wire enclosure connectors that are suitable for the selected end user application and a number of the wire enclosure connectors suitable for the selected end user application; and
obtaining the determined wire enclosure connectors,
wherein the packaging step includes packaging the obtained wire enclosure connectors into the package.

5. The method of claim 4, wherein the wire enclosure connector determining step includes determining dimensions of the wire enclosure connectors suitable for the selected end user application.

6. The method claim 4, further comprising the steps of:
determining a type or types of hardware items that are suitable for the selected end user application and a number of the hardware items suitable for the selected end user application; and
obtaining the determined hardware items,
wherein the packaging step includes packaging the obtained hardware items into the package.

7. The method of claim 6, wherein the hardware item determining step includes determining dimensions of the hardware items suitable for the selected end user application.

8. The method claim 1, further comprising the steps of:
determining a type or types of hardware items that are suitable for the selected end user application and a number of the hardware items suitable for the selected end user application; and
obtaining the determined hardware items,
wherein the packaging step includes packaging the obtained hardware items into the package.

9. The method of claim 8, wherein the hardware item determining step includes determining dimensions of the hardware items suitable for the selected end user application.

10. A wire management kit comprising:
a predetermined number of a predetermined type or types of wire enclosures suitable for a selected end user application; and
a package for containing the predetermined number and type or types of wire enclosures.

11. The kit of claim 10, wherein the predetermined number and type or types of wire enclosures are of a predetermined dimension or dimensions that is suitable for the selected end user application.

12. The kit of claim 10, wherein the wire management kit is for retail sale.

13. The kit of claim 10, further comprising a predetermined number of a predetermined type or types of wire enclosure connectors suitable for the selected end user application, wherein the package is also for containing the predetermined number and type or types of wire enclosure connectors.

14. The kit of claim 13, wherein the predetermined number and type or types of wire enclosure connectors are of a predetermined dimension or dimensions that is suitable for the selected end user application.

15. The kit of claim 10, further comprising a predetermined number of a predetermined type or types of hardware items suitable for the selected end user application, wherein the package is also for containing the predetermined number and type or types of hardware items.

16. The kit of claim 13, wherein the predetermined number and type or types of hardware items are of a predetermined dimension or dimensions that is suitable for the selected end user application.
